(19) United States
(12) Patent Application Publication
(10) Pub. No.: US 2008/0160399 A1
(43) Pub. Date: Jul. 3, 2008

(54) CRUDE CELL FOR LARGE SECONDARY BATTERY AND PREPARING METHOD THEREOF

(75) Inventors: Young Jae Kim, Chungcheongbuk-do (KR); Dong Bok Yang, Chungcheongbuk-do (KR); Jae Kook Jeong, Chungcheongbuk-do (KR); Gyu Sik Kim, Chungcheongbuk-do (KR); Bum Suk Son, Chungcheongbuk-do (KR); Won Sob Eom, Ulsan (KR); Suk Je Kim, Jeollanam-do (KR); Jong Man Woo, Chungcheongbuk-do (KR)

Correspondence Address: BELL, BOYD & LLOYD, LLP, P.O. Box 1135, CHICAGO, IL, 60690, US

(73) Assignee: SAEHAN ENERTECH, INC., Chungcheongbuk-Do (KR)

(21) Appl. No.: 11/681,274

(22) Filed: Mar. 2, 2007

(30) Foreign Application Priority Data
Dec. 29, 2006 (KR) 2006-137818

(51) Int. Cl. H01M 6/42

(52) U.S. Cl. 429/149; 29/623.5

(57) ABSTRACT

The present invention discloses a crude cell for a large secondary battery comprising unit cells alternately stacked in the fold/fold type or a crude cell for a large secondary battery comprising unit cells wound and stacked in the jelly roll type, each unit cell having an anode, a cathode and a separator, in which a polymer film is inserted in the crude cell to support the crude cell. According to the present invention, it is possible to prevent structural distortion caused by external impact and self reaction of the crude cell by firmly supporting the crude cell. Consequently, it is possible to prevent short of the anode and the cathode in the crude cell by electrical connection and to improve interfacial properties of the anode, the cathode and the separator.

### BACKGROUND

The present invention relates to a crude cell for a large secondary battery and a method for preparing the same. More particularly, the present invention relates to a crude cell for a large secondary battery comprising unit cells stacked in the fold type, in which the structure of the crude cell is firmly supported and the structural distortion is prevented by the polymer film inserted in the crude cell, whereby the short of the anode and the cathode is prevented and the interfacial adhesion of the anode, the cathode and the separator is improved, and a method for preparing the same.

In general, as the industries using high-capacity electric power such as storage battery, electric vehicle and the like are rapidly developed, a need for high-performance and high-safety secondary battery is greatly increased.

In these industries, high-capacity secondary batteries are needed, and thus large secondary batteries having a large area of an electrode plate are desired. Generally, the large secondary battery is a battery having a nominal capacity of 5.0 Ah or more or comprising a crude cell having at least of length (L) and width (W) of 100 mm or more.

Mostly, a battery is used as a power source of electric appliance such as nickel cadmium battery, nickel hydrogen battery, nickel zinc battery, lithium secondary battery and the like. Among them, the lithium secondary battery is most widely used in terms of life span and capacity. The lithium secondary battery is classified a lithium metal battery and a lithium ion battery using a liquid electrolyte, and a lithium polymer battery using a polymeric solid electrolyte according to electrolyte types. The lithium polymer battery is classified into an absolute solid type lithium polymer battery containing no organic electrolyte and a lithium ion polymer battery using a gel type polymer electrolyte containing an organic electrolyte according to its polymeric solid electrolyte types.

The large-area secondary battery is classified into a cylindrical battery, a prismatic battery and a pouch type battery according to its package type. An example of the crude cell of the conventional secondary battery is shown in FIG. 1. The crude cell 1 of the large secondary battery illustrated in FIG. 1 comprises unit cells 2 alternately stacked. The unit cell 2 comprises an anode 3, a cathode 4 and a separator 5 for separating the anode and cathode. Meanwhile, in another example, the crude cell of the secondary battery comprises a unit cell having an anode, a cathode and a separator being wound in the Jelly Roll type (not shown).

However, the conventional large secondary battery has problems in that the crude cell is deformed since the electrode interfaces are not closely adhered due to the increase of the area of the electrode plate, whereby the battery performance is deteriorated upon the charge and discharge of the battery and the anode and the cathode contact with each other to generate short.

### SUMMARY

Accordingly, the present invention has been made in view of the above-mentioned problems occurring in the prior art, and it is an object of the present invention to provide a crude cell for a large secondary battery comprising unit cells stacked in the fold type, in which the structure of the crude cell is firmly supported and the structural distortion is prevented by the polymer film inserted in the crude cell, whereby short of the anode and the cathode is prevented and the interfacial adhesion of the anode, the cathode and the separator is improved, and a method for preparing the same.

It is another object of the present invention to provide a crude cell for a large secondary battery comprising unit cells wound in the jelly roll type which firmly supports the structure of the crude cell by inserting the polymer film in the crude cell and prevents structural distortion to prevent short of the anode and the cathode improve interfacial adhesion of the anode, the cathode and the separator, and a method for preparing the same.

To accomplish the above objects, according to the present invention, there is provided a crude cell for a large secondary battery comprising unit cells alternately stacked in the fold/fold type, each unit cell having an anode, a cathode and a separator, in which a polymer film is inserted in the crude cell to support the crude cell.

In another aspect of the present invention, there is provided a crude cell for a large secondary battery comprising unit cells wound and stacked in the jelly roll type, each unit cell having an anode, a cathode and a separator, in which a polymer film is inserted in the crude cell to support the crude cell.

The polymer film is preferably disposed between the unit cell and the unit cell and more preferably disposed between unit cells in the middle of the crude cell or at both ends of the crude cell, respectively.

The polymer film has a thickness of 0.8 to 1 mm and is at least one selected from the group consisting of polycarbonate, polyethylene, polypropylene, nylon, polyacetal resins, vinyl chloride resins, polystyrene, ABS resins and acrylic resins. According to the present invention, the unit cell has a mono-cell structure of anode/separator/cathode or a bi-cell structure of anode/separator/cathode/separator/anode.

In another aspect of the present invention, there is provided a method for preparing a crude cell for a large secondary battery comprising the steps of: preparing unit cells having an anode, a cathode and a separator; preparing the crude cell by alternately stacking the unit cells in the fold/fold type; and disposing a polymer film in the middle or at both ends of the crude cell.

In another aspect of the present invention, there is provided a method for preparing a crude cell for a large secondary battery comprising the steps of: preparing unit cells having an anode, a cathode and a separator; preparing the crude cell by winding and stacking the unit cells in the jelly roll type; and disposing a polymer film in the middle or at both ends of the crude cell.

The anode which is used according to the present invention is coated with slurry containing an anode active material of at least one selected from lithium transient metal oxide, organosulfur compound and a conductive polymer.

The cathode which is used according to the present invention is coated with slurry containing a cathode active material of at least one selected from metal lithium, lithium alloy, polyacenic carbon and graphite.

The separator which is used according to the present invention is preferably a micro-porous film comprising at least one selected from polyethylene and polypropylene.

The conventional crude cell for a large secondary battery has problems in that the crude cell is deformed since the electrode interfaces are not closely adhered due to the increase of the area of the electrode plate, whereby the battery performance is deteriorated upon charge and discharge and the anode and the cathode contact with each other to generate short.

In order to solve the above-described problems, according to the present invention, a polymer film is inserted in the crude cell for a common large secondary battery. The polymer film firmly supports the structure of the crude cell and prevents distortion of the crude cell caused by external impact and reaction of itself. As a result, it is possible to prevent short of the anode and the cathode in the crude cell and to provide excellent battery performance by increasing tension between the separator and the cathode and anode upon assembly of the crude cell so that the interfaces between them are closely adhered to each other.

The polymer film which can be used according to the present invention is not particularly limited as long as it is non-reactive with the chemical reactants in the crude cell crude cell and strength enough to firmly support the structure. It includes preferably thermoplastic polymer films and more preferably at least one selected from polycarbonate, polyethylene, polypropylene, nylon, polyacetal resins, vinyl chloride resins, polystyrene, ABS resins and acrylic resins.

The polymer film which can be used according to the present invention has a thickness of preferably 0.8 to 1 mm, though it is enough to firmly support the structure of the crude cell. If the thickness is less than 0.8 mm, it is difficult to attain a desired strength since the thickness is too small. If the thickness exceeds 1 mm, the energy density and output density is reduced.

The polymer film has a size equal or similar to that of the unit cell.

The polymer film inserted according to the present invention may be preferably inserted between the adjacent unit cells in any part of the crude cell. However, in order to maximize the effect resulting from the insertion of the polymer film, it is more preferable to dispose one polymer film between the adjacent unit cells located in the middle of the crude cell or one polymer film at each of both ends of the crude cell. Meanwhile, if the number of the polymer film is too much, there may be problem since the volume of the crude cell is increased. Therefore, one or two polymer film is preferably inserted.

Additional features and advantages are described herein, and will be apparent from, the following Detailed Description and the figures.

### BRIEF DESCRIPTION OF THE FIGURES

The above and other objects, features and advantages of the present invention will be apparent from the following detailed description of the preferred embodiments of the invention in conjunction with the accompanying drawings, in which:

FIG. 1 is a cross-sectional view of a crude cell for a large secondary battery.

FIG. 2 is a cross-sectional view of the crude cell for a large secondary battery according to the first embodiment of the present invention;

FIG. 3 is a cross-sectional view of the crude cell for a large secondary battery according to the second embodiment of the present invention;

FIG. 4 is a cross-sectional view of the crude cell for a large secondary battery according to the third embodiment of the present invention;

FIG. 5 is a cross-sectional view of the crude cell for a large secondary battery according to the forth embodiment of the present invention; and

FIG. 6 is a perspective view of the secondary battery comprising the large crude cell according to a preferred embodiment of the present invention.

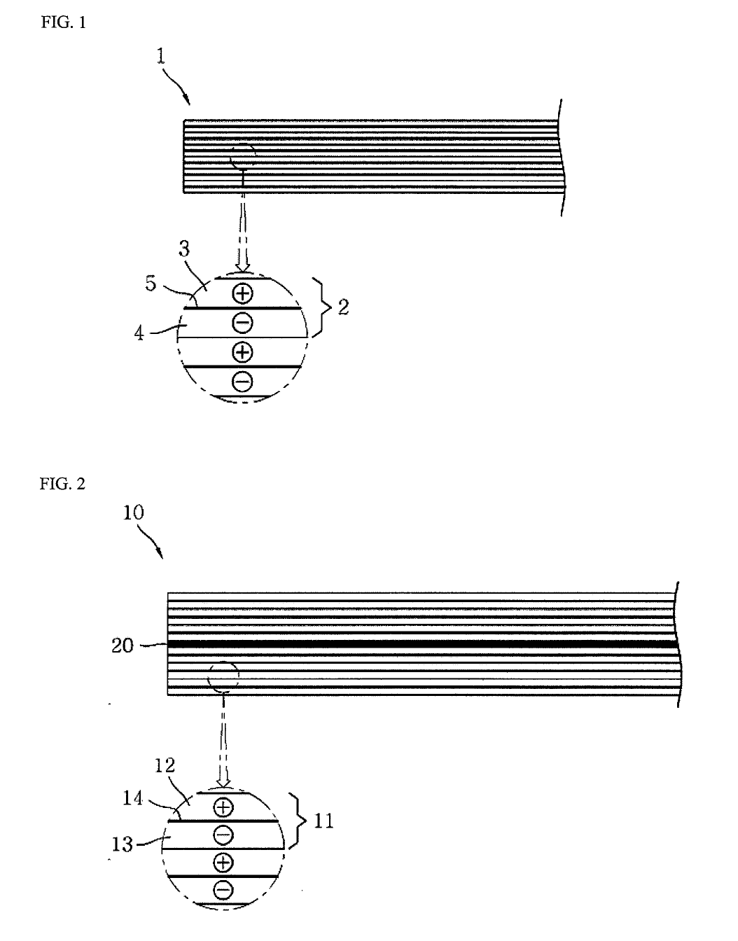

### DETAILED DESCRIPTION

Reference will now be made in detail to the preferred embodiments of the present invention, examples of which are illustrated in the accompanying drawings. However, it should be understood that the technical features of the present invention is not limited thereto.

FIG. 2 is a cross-section view of the crude cell for a large secondary battery according to the first embodiment of the present invention. Particularly, the crude cell 10 comprises unit cells 11 alternately stacked in the fold/fold type, that is, in the zigzag type, each unit cell 11 having an anode 12, a cathode 13 and a separator 14 to separate the anode and cathode. In the middle of the crude cell 10, a polymer film 20 is inserted to support the crude cell 10.

Concretely explaining the above-described composition, the anode 12 includes at least commonly used in a large secondary battery and may be coated with a conventional slurry. According to the present invention, it may be coated with slurry containing an anode active material of at least one selected from lithium transient metal oxide, organosulfur compound and a conductive polymer or a mixture thereof. Examples of the lithium transient metal oxide includes lithium cobalt oxide, lithium manganese oxide, lithium nickel oxide, lithium nickel manganese oxide, lithium nickel cobalt oxide, lithium cobalt manganese oxide and the like. Examples of the organosulfur compound include an organic disulfide compound, polycarbon disulfide compound, active sulfur and the like. Examples of the conductive polymer include a composite of polypyrrole, polyaniline, polythiophene and the like with an inorganic compound.

The anode is prepared by dissolving 60 to 90 wt % of the solid contents including 10 to 50 weight parts of a conductive material and 10 to 20 weight parts of a binding material, based on 100 weight parts of the anode active material, in 10 to 40 wt % of a solvent to form a slurry and coating the slurry on aluminum foil, followed by drying and compressing. The conductive material includes carbon blacks such as acetylene black, ketjen black EC series, Vulcan XC-72, Super-P and the like. The binding material includes PVDF (polyvinylidene fluoride), PVDF-HFP (polyvinylidene fluoride-hexafluoropropylene), PTFE (polytetrafluoroethylene), SBR (styrenebutadiene rubber) and CMC (carboxymethyl cellulose) and the like, preferably a PVDF-HFP copolymer having 2 to 25 wt % of PVDF or HFP. The solvent includes NMP (N-methylpyrrolidone) and the like.

The cathode 13 may be any cathode commonly used in a large secondary battery. According to the present invention, it may be coated with slurry containing a cathode active material of at least one selected from graphite, polyacenic carbon or metal lithium. Meanwhile, polyacene (one-dimensional graphite) is a material having an intermediate structure of acetylene and graphite, in which two polyacetylene chains are cross-linked. Polyacenoacene comprises three polyacetylene chains cross-linked. The cathode is prepared by dissolving 60 to 90 wt % of the solid contents including 10 to 50 weight parts of a conductive material and 10 to 20 weight parts of a binding material, based on 100 weight parts of the cathode active material, in 10 to 40 wt % of a solvent to form a slurry and coating the slurry on copper foil, followed by drying and compressing. The examples of usable conductive material and binding materials are as described for the anode.

Thus, the anode 12 and the cathode 13 according to the present invention has increased binding force between a current collector and the active material and reduced interfacial resistance against the current collector by directly coating a slurry prepared by dissolving the anode active material or the cathode active material with and conductive material and binding material in the solvent such as NMP on the collector foil. Meanwhile, the mixing ratio of the solvent and the anode or cathode active material is determined according to a conventional mixing ratio of the active material in the anode and the cathode. Further, it is possible to shorten the moving path of lithium ions by thinning thickness of the electrode plate and to reduce resistance of the electrode by performing roll pressing after drying.

The separator 14 is disposed between the anode 12 and the cathode 13 to intercept the direct contact between them. Examples of the separator which can be used in the present invention include preferably a micro-porous film comprising polyethylene, polypropylene or a mixture thereof, though anyone commonly used in a crude cell for a large secondary battery can be used.

The unit cell 11 comprises the anode 12, the cathode 13 and the separator 14. The unit cells 11 are alternately staked in the fold/fold type, that is, in the zigzag type to form the crude cell 10. Here, unit cell 11 has preferably a mono-cell structure of anode/separator/cathode, or a bi-cell structure of anode/separator/cathode/separator/anode or cathode/separator/anode/separator/cathode, though it is not limited as long as it can be used in a common large secondary battery.

The crude cell 10 is formed by stacking the unit cells 11. The crude cell 10 according to the present invention has at least one of width and length of preferably 100 mm or more.

Meanwhile, the main feature of the first embodiment according to the present invention is the polymer film 20 disposed in the crude cell 10. Concretely, the crude cell 10 is formed by stacking a half of the unit cells 11, locating the polymer film 20 and stacking the rest of the unit cells 11 on the top of the polymer film 20, or by stacking all of the unit cells 11 to form the crude cell 10 and inserting the polymer film 20 in the middle of the crude cell 10. The further details of the polymer film 20 are referred to the foregoing description for the polymer film. The polymer film is provided to improve the battery performance by increasing the tension between the separator and the electrode plate upon assembling of the crude cell to closely adhere the anode to the cathode. Also, it is possible to prevent distortion of the structure upon occlusion and release of lithium ions caused by electrochemical reaction of the anode and the cathode by firmly supporting the crude cell, thereby preventing short of the anode and the cathode in the cell.

FIG. 2 is a cross-sectional view of the large secondary battery crude cell according to the second embodiment of the present invention. Description of the same parts in the composition of the second embodiment to the composition of the first embodiment is omitted and only the difference is described.

In the second embodiment, a crude cell 10 is formed by stacking unit cells and disposing polymer films 20, 20′ at the end of the crude cell 10. In other words, the polymer films 20, 20′ are disposed at the top and the bottom of the crude cell 10. By this structure, in addition to the effect of the first embodiment, the crude cell can be protected from external impact by the polymer film, whereby the safety of the battery is secured.

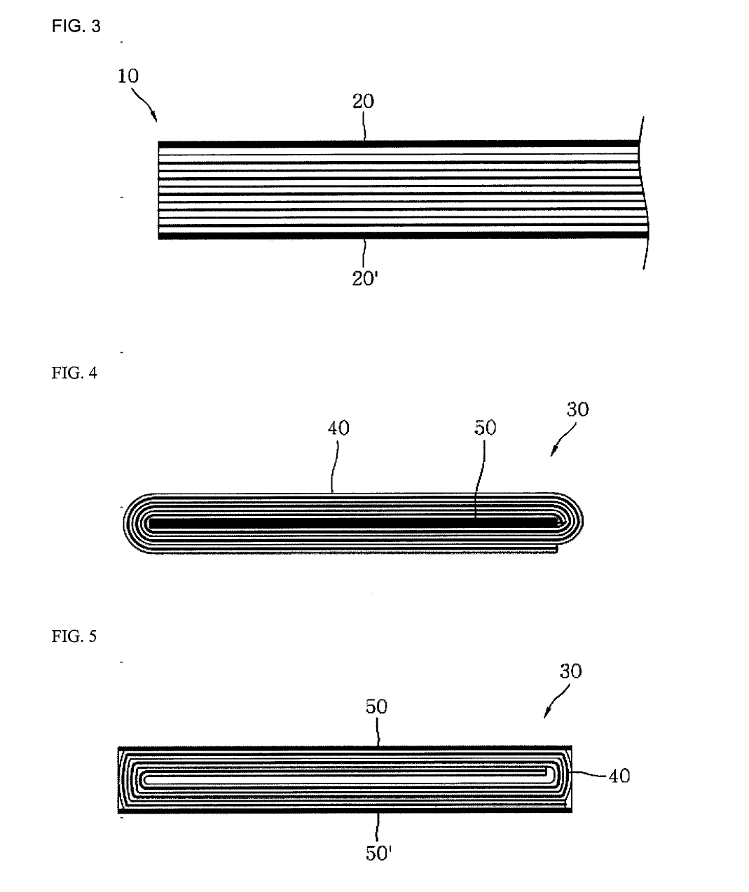

FIG. 3 and FIG. 4 are cross-sectional views of the large secondary battery crude cells according to the third and forth embodiments of the present invention. Description of the same parts in the compositions of the third and forth embodiments to the composition of the first embodiment is omitted and only the difference is described.

The main feature of the third embodiment is a polymer film inserted in a crude cell for a large secondary battery to support the crude cell, in which the crude cell comprises unit cells, each having an anode, a cathode and a separator, wound and stacked in the jelly roll type. In other words, the crude cell is formed by disposing the polymer film 40 in the center and winding the unit cells 30 around the polymer film 40 as an axis in the jelly roll.

The main feature of the fourth embodiment is polymer films 40, 40′ disposed at both ends of a crude cell, respectively, similar to the second embodiment, in which the crude cell is prepared by winding unit cells 30 in the jelly roll type.

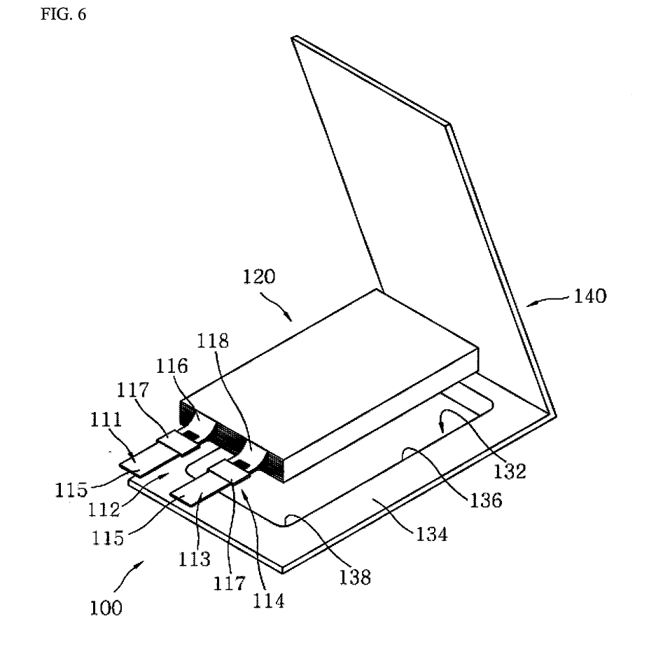

FIG. 6 is a perspective view schematically showing the structure of the large secondary battery employing the crude cell according to the present invention.

Referring to FIG. 6, the lithium secondary battery 100 comprises the crude cell 120 according to the present invention and a package 140 for receiving the cell. The crude cell 120 comprises an electrode tap for anode 112 and an electrode tap for cathode 114. The electrode tap for anode 112 is formed by welding anode grids 116 formed on anodes onto an anode tap member 111. The electrode tap for cathode 114 is formed by welding cathode grids 118 formed on cathodes onto a cathode tap member 113. The tap members 111, 113 comprise a non-resin part 115 of aluminum or nickel and a resin part 117 attached at both sides of the non-resin part 115.

The package 140 comprises a receiving part 132 for receiving the crude cell 120 and a sealing part 134 vacuum sealed after an electrolyte is injected. The receiving part 132 has a first receiving part 136 for substantially receiving the anode and cathode bodies and a second receiving part 138 for receiving electrode taps for anode and cathode 116, 118. The resin part 117 is disposed between the sealing part 134 to prevent leakage of the electrolyte (not shown) and short which may occur in the region of the tap members 111, 113.

As described above, by the crude cell for a large secondary battery according to the present invention, it is possible to prevent structural distortion caused by external impact and self reaction of the crude cell by firmly supporting the structure of the crude cell through insertion of the polymer film in the crude cell. Consequently, it is possible to prevent short of the anode and the cathode in the crude cell by electrical connection and to improve interfacial adhesion of the anode, the cathode and the separator.

While the present invention has been described with reference to the particular illustrative embodiments, it is not to be restricted by the embodiments but only by the appended claims. It is to be appreciated that those skilled in the art can change or modify the embodiments without departing from the scope and spirit of the present invention.

It should be understood that various changes and modifications to the presently preferred embodiments described herein will be apparent to those skilled in the art. Such changes and modifications can be made without departing from the spirit and scope of the present subject matter and without diminishing its intended advantages. It is therefore intended that such changes and modifications be covered by the appended claims.

The invention is claimed as follows:

1. A crude cell for a large secondary battery comprising unit cells alternately stacked in a fold/fold type, each unit cell having an anode, a cathode and a separator, and a polymer film inserted in the crude cell to support the crude cell.

2. A crude cell for a large secondary battery comprising unit cells wound and stacked in a jelly roll type, each unit cell having an anode, a cathode and a separator, a polymer film inserted in the crude cell to support the crude cell.

3. The crude cell for a large secondary battery according to claim 1, wherein the polymer film is disposed between the unit cells.

4. The crude cell for a large secondary battery according to claim 1, wherein the polymer film is disposed between unit cells in the middle of the crude cell.

5. The crude cell for a large secondary battery according to claim 1, wherein the polymer film has a thickness of 0.8 to 1 mm.

6. The crude cell for a large secondary battery according to claim 1, wherein the polymer film is at least one film selected from the group consisting of polycarbonate, polyethylene, polypropylene, nylon, polyacetal resins, vinyl chloride resins, polystyrene, ABS resins and acrylic resins.

7. The crude cell for a large secondary battery according to claim 1, wherein the unit cell has a mono-cell structure of anode/separator/cathode.

8. The crude cell for a large secondary battery according to claim 1, wherein the crude cell has at least one of width and length of 100 mm or more.

9. A method for preparing a crude cell for a large secondary battery comprising the steps of:
preparing unit cells having an anode, a cathode and a separator;
preparing the crude cell by alternately stacking the unit cells in a fold/fold type; and
disposing a polymer film in the middle or at both ends of the crude cell.

10. A method for preparing a crude cell for a large secondary battery comprising the steps of:
preparing unit cells having an anode, a cathode and a separator;
preparing the crude cell by winding the unit cells in a jelly roll type; and
disposing a polymer film in the middle or at both ends of the crude cell.

11. The method according to claim 9, wherein the anode is coated with a slurry containing an anode active material of at least one material selected from the group consisting of lithium transient metal oxide, organosulfur compound and a conductive polymer and a mixture thereof.

12. The method according to claim 9, wherein the cathode is coated with a slurry containing a cathode active material selected from the group consisting of graphite, polyacenic carbon and metal lithium.

13. The method according to claim 9, wherein the separator is a micro-porous film comprising at least one selected from polyethylene and polypropylene.

14. The method according to claim 9, wherein the crude cell has at least one of width and length of 100 mm or more.

15. A large secondary battery comprising a crude cell for a large secondary battery defined in claim 1.

16. The crude cell for a large secondary battery according to claim 2, wherein the polymer film is disposed between the unit cells.

17. The crude cell for a large secondary battery according to claim 1, wherein the polymer film is disposed between unit cells at both ends of the crude cell.

18. The crude cell for a large secondary battery according to claim 1, wherein the polymer film has a thickness of 0.8 to 1 mm.

19. The crude cell for a large secondary battery according to claim 2, wherein the polymer film is at least one film selected from the group consisting of polycarbonate, polyethylene, polypropylene, nylon, polyacetal resins, vinyl chloride resins, polystyrene, ABS resins and acrylic resins.

20. The crude cell for a large secondary battery according to claim 1, wherein the unit cell has a bi-cell structure of anode/separator/cathode/separator/anode.

21. The crude cell for a large secondary battery according to claim 1, wherein the crude cell has at least one of width and length of 100 mm or more.

22. The method according to claim 10, wherein the anode is coated with a slurry containing an anode active material of at least one material selected from the group consisting of lithium transient metal oxide, organosulfur compound and a conductive polymer and a mixture thereof.

23. The method according to claim 10, wherein the cathode is coated with a slurry containing a cathode active material of at least one material selected from the group consisting of graphite, polyacenic carbon and metal lithium.

24. The crude cell for a large secondary battery according to claim 2, wherein the polymer film is disposed between unit cells in the middle of the crude cell.

25. The crude cell for a large secondary battery according to claim 2, wherein the unit cell has a mono-cell structure of anode/separator/cathode.

26. The crude cell for a large secondary battery according to claim 2, wherein the polymer film is disposed between unit cells at both ends of the crude cell.

27. The crude cell for a large secondary battery according to claim 2, wherein the unit cell has a bi-cell structure of anode/separator/cathode/separator/anode.
